(19) United States
(12) Patent Application Publication
(10) Pub. No.: US 2020/0021943 A1
(43) Pub. Date: Jan. 16, 2020

(54) METHOD FOR INFERRING DEVICE LOCATION WITH MISSING LOCATION DATA

(71) Applicant: Passport Labs, Inc., Charlotte, NC (US)

(72) Inventors: Michael N.B. Scully, Charlotte, NC (US); Raymond Robinson, Charlotte, NC (US)

(21) Appl. No.: 16/509,072

(22) Filed: Jul. 11, 2019

Related U.S. Application Data
(60) Provisional application No. 62/696,999, filed on Jul. 12, 2018.

(51) Int. Cl. H04W 4/02; H04W 4/029; G06Q 50/30; G06Q 30/02

(52) U.S. Cl. CPC H04W 4/023; H04W 4/029; G06Q 2240/00; G06Q 30/0283; G06Q 50/30

(57) ABSTRACT

A method of determining the physical location of a primary mobile computing device includes: collecting at least one locating factor through a data communications connection, wherein the at least one locating factor at least partially identifies a physical location of the primary mobile computing device, wherein the at least one locating factor includes a known position of a secondary mobile computing device; using an electronic processor, executing at least one software rule to make a location inference of the physical location of the primary mobile computing device, based on the at least one locating factor; and storing the result of the location inference for further use.

### BACKGROUND OF THE INVENTION

This invention relates generally to location methods, and more particularly to a method for inferring the location of a portable electronic device.

It is known to use a software application running on a mobile computing device to track a user's location and ultimately to report that location to a remote computer system. More specifically, the software application may be used to report that the mobile computing device has passed a significant geographic location (e.g. a toll plaza) in a specific time. The remote computer system may use the location information for purposes such as calculation and payment of fees, for example road tolls or parking fees. Tolling, in particular, is dependent on accurate reported location data.

One problem with prior art systems is that mobile device detection of location can intermittently fail for numerous reasons. Failure to report a key point on the toll trip can result in the inability to calculate applicable toll from the data available.

### BRIEF SUMMARY OF THE INVENTION

This problem is addressed by an automated method of inferring the location of a mobile computing device with limited location data.

According to one aspect of the technology described herein, a method of determining the physical location of a primary mobile computing device includes: collecting at least one locating factor through a data communications connection, wherein the at least one locating factor at least partially identifies a physical location of the primary mobile computing device, wherein the at least one locating factor includes a known position of a secondary mobile computing device; using an electronic processor, executing at least one software rule to make a location inference of the physical location of the primary mobile computing device, based on the at least one locating factor; and storing the result of the location inference for further use.

According to another aspect of the technology described herein, a method of determining the physical location of a primary mobile computing device includes: moving the primary mobile computing device into a primary vehicle; using the primary vehicle, travelling over a road route structure including two or more checkpoints, while travelling over the road route structure, collecting at least one locating factor through a data communications connection, wherein the at least one locating factor at least partially identifies a physical location of the primary mobile computing device, wherein the at least one locating factor includes a known position of a secondary mobile computing device; using an electronic processor, executing at least one software rule to make a location inference of the physical location of the primary mobile computing device, based on the at least one locating factor; and storing the result of the location inference for further use.

### BRIEF DESCRIPTION OF THE DRAWINGS

The invention may be best understood by reference to the following description taken in conjunction with the accompanying drawing figures, in which:

FIG. 1 is a schematic diagram of an exemplary system for determining mobile computing device location; and

FIG. 2 is a schematic diagram of a vehicle traveling along a road route system.

### DETAILED DESCRIPTION OF THE INVENTION

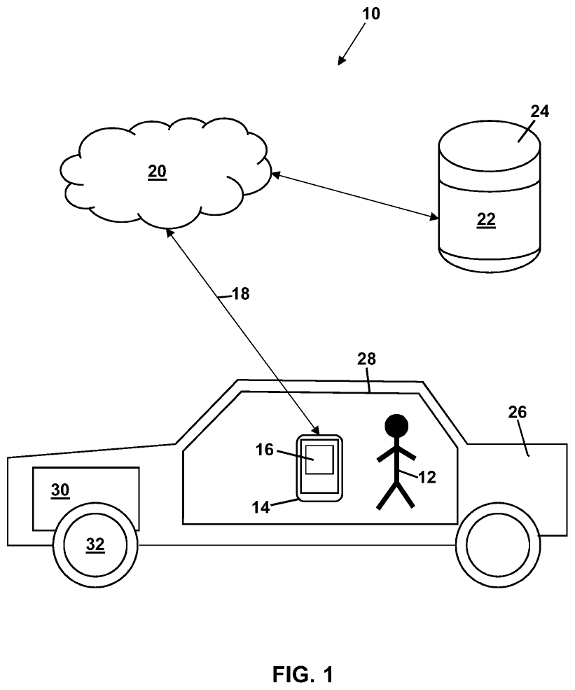

Referring to the drawings wherein identical reference numerals denote the same elements throughout the various views, FIG. 1 illustrates an exemplary mobile system 10 for use by one or more users 12.

The method of the present invention is implemented using a conventional mobile computing device 14. The mobile computing device 14 includes one or more microprocessors operable to execute programmed instructions and supporting components such as an electrical power source (e.g. battery), input/output devices (e.g. keyboard, touchscreen display, microphone, and/or speakers), and one or more transceivers operable to communicate data over various wireless protocols including but not limited to BLUETOOTH, Wi-Fi, and/or cellular networks. The mobile computing device 14 may include one or more physical data ports for two-way data transmission, for example a port compatible with a universal serial bus (USB) cable. Nonlimiting examples of commercially-available mobile computing devices include laptop computers, tablet computers, “smart watches”, and “smartphones”. A mobile computing device could also include other types of devices such as vehicle “infotainment” systems, alone or in combination with other devices.

The mobile computing device 14 implements at least one location service, defined as a combination of hardware and software operable to determine the geographic location of the mobile computing device 14. Nonlimiting examples of location services include inertial navigation systems, satellite-based navigation (e.g. GPS, GLONASS), WiFi-based location, and cellular-based location.

In the illustrated example, the mobile computing device 14 is a conventional smartphone. The mobile computing device 14 is provisioned with a client software program (also referred to as a “client application” or “client app” 16) containing appropriate programming for carrying out the method described herein.

The mobile computing device 14 is connected by a communications channel 18 such as a Wi-Fi or a cellular data connection to a wide area network 20 such as the Internet.

The system 10 may include a backend application 22 which communicates with the client app 16 through the wide area network 20. It will be understood that the backend application 22 may be hosted on one or more servers or individual user devices, which are connected to the wide area network 20. A single server 24 hosting the backend application 22 is depicted schematically in block diagram format. It will be understood that multiple servers or groups of servers could be used.

The steps of the location method may be carried out on one or more processors. It will be understood that the method may be carried out entirely using processors contained within the mobile computing device 14, or entirely using processors contained external to the mobile computing device (e.g. in the server 24 or on another mobile or fixed computing device that is also connected to the backend application 22 or client app 16 and the wide area network 20), or by some combination of the two.

The mobile computing device 14 may be used in conjunction with a vehicle 26, shown schematically in FIG. 1. For descriptive purposes this may be referred to as a “primary” vehicle, and the mobile computing device 14 may be referred to as a “primary” mobile computing device.

The illustrated vehicle 26 includes a passenger compartment 28 and a drivetrain of a known type, such as the illustrated prime mover 30 which is coupled to wheels 32 through a transmission (not shown). The principles described herein are applicable to all types of vehicles, including mass transit vehicles such as buses or trains, and including those without passenger compartments, such as cargo vehicles, unmanned vehicles, etc.

In operation, the passenger compartment 28 may be occupied by the user 12 along with his or her mobile computing device 14.

The location inference method described herein is suitable for use within a method or system which depends on accurate determination that the mobile computing device 14 is located at, or has passed through, a significant geographic location within a specific time window. One example of such a method is an automated road tolling system.

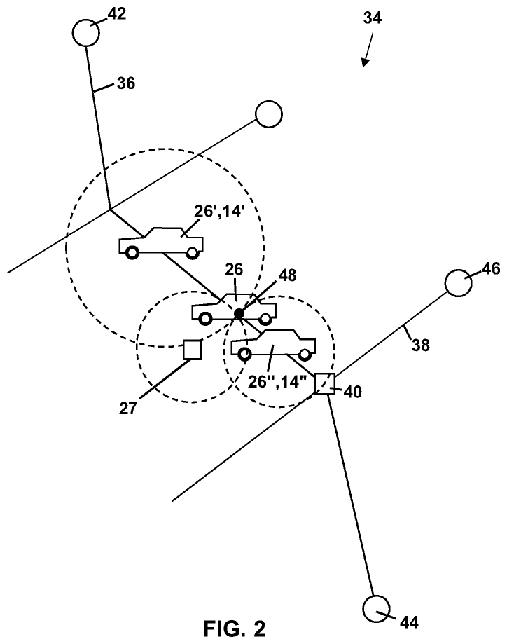

FIG. 2 is a diagram of road route structure 34 comprising a primary road 36 and a secondary road 38 which intersects the primary road 36. A checkpoint in the form of a toll plaza 40 is positioned on the primary road 36.

As an example, the vehicle 26 may travel along the primary road 36 from a starting point 42, passing through toll plaza 40 on its way to an end point 44, 46. While a vehicle travelling on a road is used as an example, it will be understood that the principles described herein are equally applicable to vehicles travelling off-road, stationary vehicles, or land or sea vehicles.

One or more of the location services described above may be used to determine the location of the mobile computing device 14 and to report that location to a remote computing device. For example, when the location service determines the mobile computing device 14 is at the toll plaza 40 at a specific time, this date and location information may be reported to the server 24. This information may then be used to charge a toll to user 12.

However, as noted above, this specific location determination may be unavailable. This could occur through an equipment or software failure.

For example, accurate location information may be available at a first waypoint 48 in the trip prior to the toll plaza 40 and at a second point in the trip after the toll plaza 40, for example at one of the endpoints 44, 46, but not at or near the toll plaza 40.

Accordingly, the backend application 22 and/or the client app 16 may be programmed with one or more rules or algorithms that function to make an inference that the mobile computing device 14 is in a specific location in a specific time, in the absence of direct, contemporaneous location information. This may be referred to as a “location inference”.

In making the location inference, the system 10 collects and refers to pieces of information or facts referred to herein as “locating factors”, each of which identifies a specific vehicle to some degree. The vehicle determination may be based on one or multiple locating factors. Generally speaking, the greater the number of locating factors that imply a specific vehicle, the greater the confidence in the vehicle determination.

The system 10 may incorporate machine learning strategies and/or statistical methods and/or empirical methods to improve the location inference using multiple locating factors. For example, the system 10 may identify a combination of multiple locating factors, none of which individually locate the vehicle 26, but which in combination permit a location inference having sufficient accuracy for practical use.

Examples of potential locating factors which may be used to make the location inference are listed below.

Location data received from the application on the mobile computing device 14 prior to the missed event may allow a location inference. For example, in a trip from starting point 42 to endpoint 44, the vehicle 26 may be accurately located at the first waypoint 48. The location and time of first waypoint 48 may serve as one reference point in an interpolation process and/or a known point from which a later position could be determined by deduced reckoning going forward.

Similarly, location data received from the application on the mobile computing device 14 after the missed event may allow the location inference. For example, in a trip from starting point 42 to endpoint 44, the vehicle may be accurately located at the end point 44. The location and time of the endpoint 44 may serve as an endpoint in an interpolation process and/or a known point from which a previous position could be determined by deduced reckoning going backwards.

Location data or previously observed trip data may be used as a locating factor. For example, a profile may be maintained of the user's driving habits. This profile may include information such as the trip end points, the average speed between the endpoints, the typical route taken between the endpoints, a representative series of stored locations along the endpoints, and/or record of average elapsed time between the starting point 42 and the event such as the toll plaza 40. If the system 10 identifies the vehicle 26 as being located at one or more points matching a profile, the system 10 may infer that the present trip matches a profile and may then use that profile as a reference to infer a location event. For example, if a typical trip begins a starting point 42, passes toll plaza 40 at 30 minutes elapsed time from the beginning, and ends at endpoint 44 at 60 minutes elapsed time from the beginning of the trip, then an estimated passing of the toll plaza 40 may be interpolated forwards or backwards given at least one data point including time and position.

Similarly, profiles may be maintained for a group of many users, and the individual trip may be matched against the profiles of popular trip patterns.

Data observed from other devices having a known location may be used to locate the mobile computing device 14. As used herein, the term “known location” refers to a location which is adequately identified through means which have sufficient accuracy and reliability for the intended application as determined by the user of the system 10. The term “known” does not necessarily imply a specific level of accuracy of the location. For example, FIG. 2 illustrates second and third mobile computing devices 14′, 14″ vehicles 26′, 26″ respectively which may be assumed to report valid location and time information, and which may be carried in second and third vehicles 26′, 26″, respectively. Either or both mobile computing devices 14′, 14″ may be referred to as “secondary” mobile computing devices for descriptive purposes. Either or both vehicles 26′, 26″ may be referred to as “secondary” vehicles for descriptive purposes. The position of the mobile computing device 14 (and thus vehicle 26) may be inferred based on its relative position to the second and third mobile computing devices 14′, 14″. In essence, the other mobile computing devices 14′, 14″ would be relaying (to the backend application 22) their locations, along with information about the proximity and/or relative location of the mobile computing device 14. The second or third mobile computing devices 14′, 14″ may observe the proximity or presence of the mobile computing device 14 through means such as receiving its wireless transmissions. If a wireless transmission is received by the second or third mobile computing devices 14′, 14″, a reasonable inference may be made to the mobile computing device 14 is within a given maximum distance from the second or third mobile computing device 14′, 14″ based on knowledge of the signal propagation of the type of wireless signal (e.g. based on the frequency and/or transmission protocol). This true even if the mobile computing devices 14, 14′, 14″ are not in active two-way communication with each other. Alternatively, relative position may be inferred using techniques such as sensing wireless signal characteristics such as signal strength. Relative positions from one or multiple distinct locations can permit an accurate location estimate, as shown by the intersection of the dashed-line range circles. Another example of an external source of location information that could be used in a similar fashion would be a stationary device such as a Wi-Fi router or access point located at fixed, known coordinates, which is shown schematically at 27.

Similarly, data observed from the mobile computing device 14 for other devices with a known location may be used to locate the mobile computing device 14. For example, the mobile computing device 14 may be able to determine its proximity or position relative to second and third mobile computing devices 14′, 14″ or other stationary device 27, which may be assumed to report valid location and time information. The mobile computing device 14 could report its proximity or relative position to the backend application 22. The position of the mobile computing device 14 (and thus vehicle 26) may then be inferred based on its relative position to the second and third mobile computing devices 14′, 14″ or other stationary device 27. The inference may be made by the client app 16, the backend application 22, or by some combination thereof.

Relative position of the mobile computing devices 14, 14′, 14″ may additionally be inferred at least in part based upon observation of position and/or velocity commonalities between or among the mobile computing devices 14, 14′, 14″. For example, if the primary mobile computing device 14 and one of the secondary mobile computing devices 14′, 14″ report to the backend application 22 matching or closely similar (e.g. within measurement error) headings, matching or closely similar speeds, or matching or closely similar velocities, an inference may be made the mobile computing devices are in the same vicinity. For example, they may be traveling on the same route, such as a rail line, road, or road segment.

Similarly, if the primary mobile computing device 14 and one of the secondary mobile computing devices 14′, 14″ report to the backend application 22 that they are in close proximity to each other (e.g. close enough to observe the presence of their mutual wireless signals) for a predetermined minimum time interval, an inference may be made that they are traveling on the same road or road segment. For example, the predetermined minimum time interval might be set at a value longer than would be expected in a single brief encounter, such as when two vehicles pass through the intersection of roads which cross each other. An extended interval of close proximity, such as one or more minutes, is more likely to indicate the mobile computing devices are in the same vicinity. For example, they may be traveling on the same route, such as a rail line, road, or road segment.

Physical data such as accelerometer or inclinometer output from the mobile computing device 14 (e.g. acceleration, velocity, distance, and/or orientation) may be used in conjunction with other locating factors. Based on vehicle characteristics. For example, measured data of acceleration versus time, or velocity versus time may be used to determine a vehicle position given a known starting point (deduced reckoning).

An example of the operation of the system 10 is described as follows. Initially, the client app 16 is installed on the user's mobile computing device 14. The user 12 may register a user account or otherwise establish connectivity with the backend server 24.

The client app 16 may be used by having the client app 16 active (e.g., running in the foreground or background) while the mobile computing device 14 is within the passenger compartment 28 of the vehicle 26. The client app 16 does not necessarily have to be running if locating factors are being determined using one or more other sources such as the second or third vehicles 26′, 26″ or the other device 27.

The mobile computing device 14 receives and/or collects locating factors as described above. These locating factors are received and/or collected through at least one data communications connection. This term generally refers to the transmission and reception of electronic data. The data communications connection may be two-way or one-way and may be of a connected or “connectionless” nature. In other words, the mobile computing device 14 need not be connected to a data network using any specific protocol in order to received and/or collect locating factors. This information may be collected continuously. (E.g. location information, wireless signal changes, acceleration, etc.)

The system 10 executes the rules and/or algorithms to make a location inference based on the locating factors described above. The location inference is then available for use by the client app 16 and the backend application 22.

For example, the location inference may be used automatically for transactions related to roads tolls, parking fees, etc. The most likely tolling point may be used in conjunction with other data to determine appropriate toll amounts, and the user 12 is properly charged for the trip.

The foregoing has described a system and method for inferring the location of a mobile computing device. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of determining the physical location of a primary mobile computing device comprising:
collecting at least one locating factor through a data communications connection, wherein the at least one locating factor at least partially identifies a physical location of the primary mobile computing device, wherein the at least one locating factor includes a known position of a secondary mobile computing device;
using an electronic processor, executing at least one software rule to make a location inference of the physical location of the primary mobile computing device, based on the at least one locating factor; and
storing the result of the location inference for further use.

2. The method of claim 1 further comprising:
establishing a location of the secondary mobile computing device;
determining at least one of a proximity or a relative location of the primary mobile computing device to the secondary mobile computing device;
relaying to a backend application the location of the secondary mobile computing device and the proximity or relative location of the primary mobile computing device.

3. The method of claim 2 wherein the relative position or the proximity of the primary mobile computing device to the secondary mobile computing device is inferred by measuring signal characteristics of a wireless signal travelling between the primary and secondary mobile computing devices.

4. The method of claim 3 wherein the mobile computing devices are not in active two-way data communication with each other.

5. The method of claim 1 wherein the location inference of the primary mobile computing device is made at least in part in response to the primary and secondary mobile computing devices having a common heading, speed, or velocity.

6. The method claim 1 wherein the location inference of the primary mobile computing device is made at least in part in response to the primary and secondary mobile computing devices having close proximity to each other for a predetermined minimum time interval.

7. The method of claim 2 wherein the location of the secondary mobile computing device and the relative position or proximity of the primary computing device are relayed to the backend application from the secondary mobile computing device.

8. The method of claim 2 wherein the steps of establishing, determining, and relaying are carried out with two or more secondary mobile computing devices.

9. The method of claim 2 wherein:
the location of the secondary mobile computing device is relayed from the secondary mobile computing device to the backend application; and
the proximity or relative location of the primary mobile computing device is relayed from the primary mobile computing device to the backend application.

10. The method of claim 2 wherein:
the location of the secondary mobile computing device is relayed from the secondary mobile computing device to the primary mobile computing device; and
the proximity or relative location of the primary mobile computing device and the location of the secondary mobile computing device are relayed from the primary mobile computing device to the backend application.

11. The method of claim 1 wherein the at least one locating factor includes location information received wirelessly from a stationary device located at fixed, known coordinates.

12. The method of claim 1 wherein the at least one locating factor includes previously observed trip data.

13. The method of claim 1 wherein the at least one locating factor includes physical sensor data.

14. A method of determining the physical location of a primary mobile computing device, comprising:
moving the primary mobile computing device into a primary vehicle;
using the primary vehicle, travelling over a road route structure including two or more checkpoints,
while travelling over the road route structure, collecting at least one locating factor through a data communications connection, wherein the at least one locating factor at least partially identifies a physical location of the mobile computing device, wherein the at least one locating factor includes a known position of a secondary mobile computing device;
using an electronic processor, executing at least one software rule to make a location inference of the physical location of the primary mobile computing device, based on the at least one locating factor; and
storing the result of the location inference for further use.

15. The method of claim 14 further comprising:
establishing a location of the secondary mobile computing device;
determining at least one of a proximity or a relative location of the primary mobile computing device to the secondary mobile computing device; and
relaying to the backend application the location of the secondary mobile computing device and the proximity or relative location of the primary mobile computing device.

16. The method of claim 15 wherein the relative position or the proximity of the primary mobile computing device to the secondary mobile computing device is inferred by measuring signal characteristics of a wireless signal travelling between the primary and secondary mobile computing devices.

17. The method of claim 16 wherein the mobile computing devices are not in active two-way data communication with each other.

18. The method of claim 14 wherein the location inference of the primary mobile computing device is made at least in part in response to the primary and secondary mobile computing devices having a common heading, speed, or velocity.

19. The method claim 14 wherein the location inference of the primary mobile computing device is made at least in part in response to the primary and secondary mobile computing devices having close proximity to each other for a predetermined minimum time interval.

20. The method of claim 15 wherein the location of the secondary mobile computing device and the relative position or proximity of the primary computing device are relayed to the backend application from the secondary mobile computing device.

21. The method of claim 15 wherein the steps of establishing, determining, and relaying are carried out with two or more secondary mobile computing devices.

22. The method of claim 14 wherein:
the location of the secondary mobile computing device is relayed from the secondary mobile computing device to the backend application; and
the proximity or relative location of the primary mobile computing device is relayed from the primary mobile computing device to the backend application.

23. The method of claim 14 wherein:
the location of the secondary mobile computing device is relayed from the secondary mobile computing device to the primary mobile computing device; and
the proximity or relative location of the primary mobile computing device and the location of the secondary mobile computing device are relayed from the primary mobile computing device to the backend application.

24. The method of claim 14 wherein the at least one locating factor includes location information received wirelessly from a stationary device located at fixed, known coordinates.

25. The method of claim 14 wherein the at least one locating factor includes previously observed trip data.

26. The method of claim 15 wherein the at least one locating factor includes physical sensor data.

27. The method of claim 14 further comprising:
collecting data including at least one of: location and speed during one or more trips of the primary mobile computing device in a vehicle; and
storing the collected data as a profile.

28. The method of claim 27 wherein the electronic processor makes the location inference at least in part by reference to the profile.

29. The method of claim 14 wherein the electronic processor makes the location inference at least in part by interpolating forwards or backwards from a known location along the road route structure.
